(19) United States
(12) Patent Application Publication
(10) Pub. No.: US 2015/0268877 A1
(43) Pub. Date: Sep. 24, 2015

(54) SYSTEMS AND METHODS FOR RECORDING DATA IN A MEMORY

(71) Applicant: GM GLOBAL TECHNOLOGY OPERATIONS LLC, Detroit, MI (US)

(72) Inventor: FRED W. HUNTZICKER, ANN ARBOR, MI (US)

(73) Assignee: GM GLOBAL TECHNOLOGY OPERATIONS LLC, Detroit, MI (US)

(21) Appl. No.: 14/222,308

(22) Filed: Mar. 21, 2014

(51) Int. Cl. G06F 3/06

(52) U.S. Cl. CPC G06F 3/0619; G06F 3/0644; G06F 3/0689

(57) ABSTRACT

Methods and systems are provided for recording data in a vehicle. The system includes a processor configured to receive data from at least one data source and sample the data at a first sampling rate. A memory is in communication with the processor, the memory including a plurality of storage locations each identified with a unique address. The processor is further configured to determine a current storage location address for a latest sample of the data at the first sampling rate such that older samples of data are retained at a second sampling rate less frequent than the first sampling rate.

### TECHNICAL FIELD

The technical field generally relates to systems and methods for recording data in a memory, and more particularly relates to systems and methods for recording data in a memory at a plurality of sampling rates.

### BACKGROUND

Data regarding operation of a vehicle is often stored to a memory device, or simply, a “memory”, for later retrieval and use. One common technique for storing such data is a circular buffer where the data is recorded sequentially at a defined rate. After each recording, the address of the memory storage location is incremented, so that the memory fills up sequentially. When an upper limit of the memory is reached, the address is reset to a beginning location and data is over-written from the beginning location. The memory addresses to be written to can be expressed as:

Addₛ=Addₘᵢₙ+Tₛ mod n

wherein Addₛ is the current address that is being written to, Addₘᵢₙ is the minimum (or beginning) memory address, Tₛ is an incrementing time sample (e.g., 0, 1, 2, 3, . . . ), and n is the number of memory locations.

One drawback of this technique is that all of the data is written at a single sampling rate. Therefore, a large memory device is required to record data for a large period of time while providing for a fast sampling rate close to an event, e.g., an airbag deployment event. To save on the amount of storage locations that are required in a memory, it may be beneficial for older data to only be retained at a slower sampling rate while still maintaining the fast sampling rate near the event.

Accordingly, it is desirable to provide systems and methods that allows for storing data at multiple sampling rates. Furthermore, other desirable features and characteristics of the present invention will become apparent from the subsequent detailed description and the appended claims, taken in conjunction with the accompanying drawings and the foregoing technical field and background.

### SUMMARY

A method is provided for recording data in a memory having a plurality of data storage locations. In one embodiment, the method includes receiving data and sampling the data at a first sampling rate. The method also includes determining a current storage location address for a latest sample of the data at the first sampling rate such that older samples of data are retained at a second sampling rate less frequent than the first sampling rate. The method further includes storing the latest sample of the data at the current storage location address.

In one embodiment, a system is provided for recording data. The system includes a processor configured to receive data from at least one data source and sample the data at a first sampling rate. A memory is in communication with the processor, the memory including a plurality of storage locations each identified with a unique address. The processor is further configured to determine a current storage location address for a latest sample of the data at the first sampling rate such that older samples of data are retained at a second sampling rate less frequent than the first sampling rate.

In one embodiment, a vehicle is provided. The vehicle includes a sensor for sensing an aspect of the vehicle. A processor is configured to receive data from the sensor and sample the data at a first sampling rate. A memory is in communication with the processor, the memory including a plurality of storage locations each identified with a unique address. The processor is further configured to determine a current storage location address for a latest sample of the data at the first sampling rate such that older samples of data are retained at a second sampling rate less frequent than the first sampling rate.

### DESCRIPTION OF THE DRAWINGS

The exemplary embodiments will hereinafter be described in conjunction with the following drawing figures, wherein like numerals denote like elements, and wherein:

FIG. 1 is a block diagram of a system for storing data in accordance with an embodiment;

FIG. 2 is a table representing a memory in accordance with an embodiment;

FIG. 3 is flowchart showing a method of storing data in accordance with an embodiment;

FIG. 4 is a table representing a memory in accordance with an exemplary embodiment;

FIG. 5 is a graph showing data storage locations over time in accordance with the embodiment of FIG. 4;

FIG. 6 is a graph showing data storage locations over time in accordance with an exemplary embodiment; and

FIG. 7 is a graph showing sampling rates over time in accordance with the embodiment of FIG. 6.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

Referring to the Figures, wherein like numerals indicate like parts throughout the several views, a system 100 and method 300 of recording data is shown and described herein. In the exemplary embodiments, the method 300 is implemented with the computerized system 100. In one exemplary embodiment, the computerized system 100 may be integrated with a vehicle 102, e.g., an automobile. However, it is to be appreciated that the method 300 may be implemented with other devices (not shown), including non-vehicular applications.

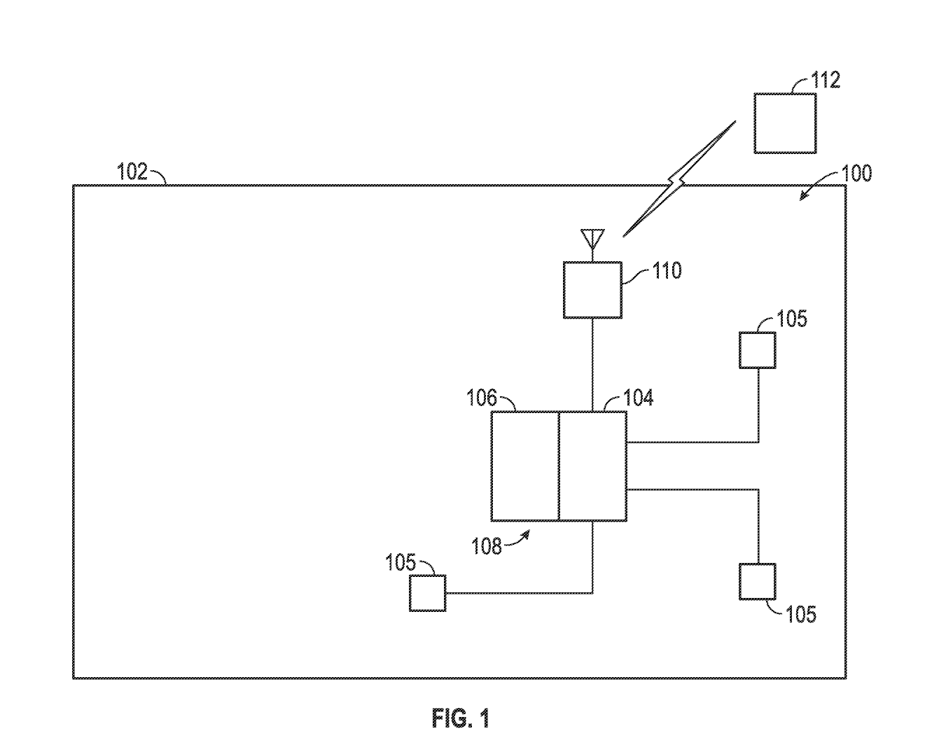

Referring to FIG. 1, the system 100 of the exemplary embodiment includes a processor 104. The processor 104 is a device capable of executing instructions (i.e., running a program) and/or performing calculations. The processor 104 may be part of an integrated circuit, i.e., a semiconductor device, as is well known to those skilled in the art. The processor 104 of the exemplary embodiment includes a plurality of inputs (not numbered) and outputs (not numbered) capable of sending and receiving signals, data, and/or other information.

The processor 104 is in communication with at least one data source 105 for receiving data. In the exemplary embodiment, the at least one data source 105 is a system or sensor related to operation of the vehicle 102. For example, the data source 105 may be an accelerometer. As such, the accelerometer provides a signal which encodes data corresponding to an acceleration/deceleration of the vehicle 102. The processor 104 may include hardware and/or software to decode the signal to obtain the data, as is well known to those skilled in the art.

Of course, the data source 105 is not limited to an accelerometer or even to vehicular applications. In another example, the data source 105 may be a temperature sensor for sensing temperature of cooling water used in an engine (not shown) of the vehicle 102. In a non-vehicle example, the data source 105 may be a wind sensor for measuring the speed of wind.

The system 100 also includes a memory 106 capable of storing data and/or other information. The memory 106 may be implemented with a semiconductor device, e.g., random access memory (RAM) or flash memory. The memory 106 may also be implemented with a magnetic storage device, e.g., a hard drive or a floppy drive. The memory 106 may further be implemented as an optical storage device, e.g., a CD-ROM or a DVD. Those skilled in the art realize other media and techniques for implementing the memory 106.

The memory 106 is in communication with the processor 104. As such, the processor 104 may communicate data received to the memory 106 for storage. In the exemplary embodiment, the memory 106 is integrated with the processor 104, i.e., part of the same integrated circuit 108. However, the memory 106 and the processor 104 may be separate and distinct components, as is readily appreciated by those skilled in the art. The vehicle 102 may also include a radio 110 in communication with the processor 104.

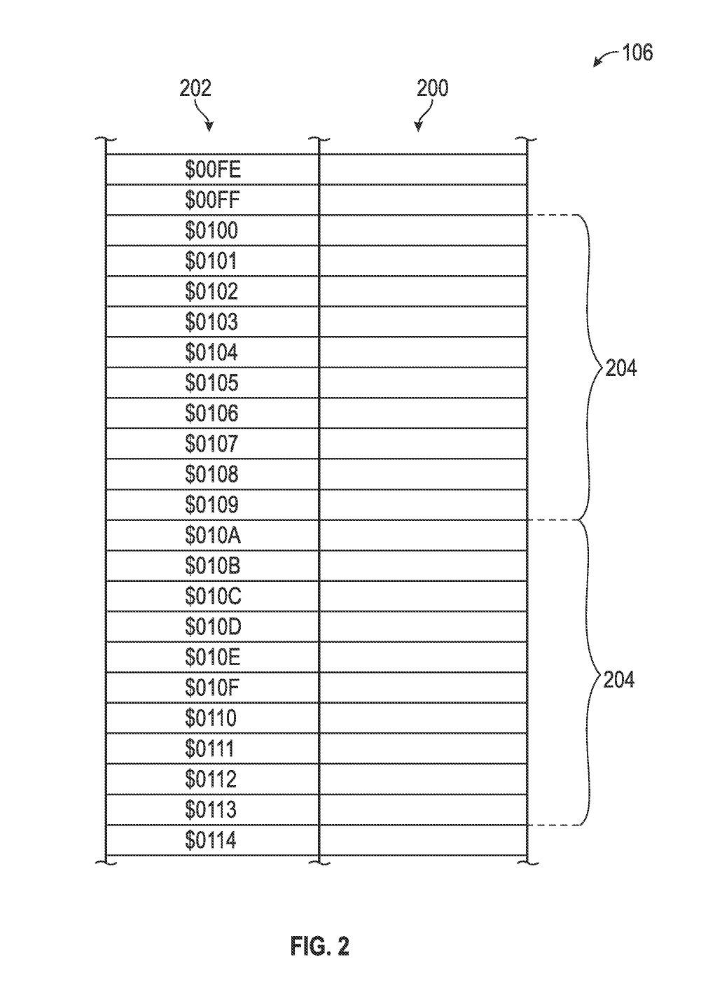

Referring now to FIG. 2, the memory 106 includes a plurality of memory locations 200. The memory locations 200 are identified with unique storage location addresses 202. As such, the processor 104 is capable of storing data in specific memory locations 200 corresponding to the storage location addresses 202. A plurality of memory locations 200 may be grouped together as an array 204. Furthermore, the memory 106 may be sectioned into a plurality of arrays 204.

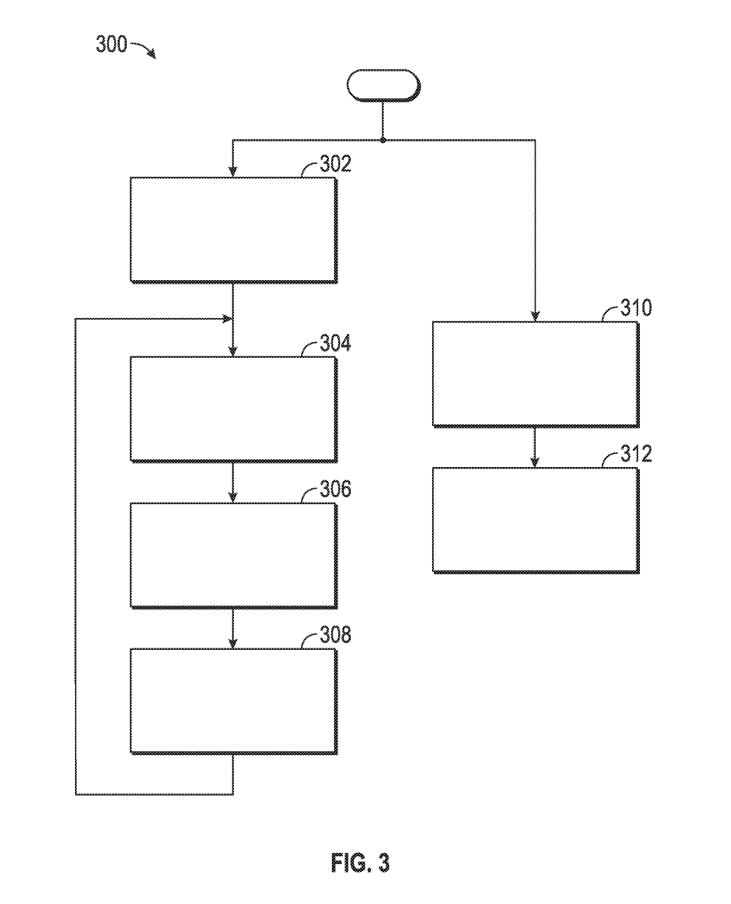

With reference to FIG. 3, and continued reference to FIGS. 1 and 2, one exemplary method 300 is shown. As can be appreciated in light of the disclosure, the order of operation within the method 300 is not limited to the sequential execution as illustrated in FIG. 3, but may be performed in one or more varying orders as applicable and in accordance with the present disclosure. As can further be appreciated, one or more steps of the method 300 may be added or removed without altering the spirit of the method 300. The method 300 shown and described herein may run substantially continuously during the operation of the vehicle 102. However, the method 300 may alternatively run during predefined time periods or as desired by a user.

The method 300, includes, at 302, receiving data. When implemented with the exemplary system 100 described above, the processor 104 is configured to receive data from the at least one data source 105. Of course, receiving data may be implemented as receiving a signal on which the data is encoded and then decoding the signal to obtain the data, as is well known to those skilled in the art.

The received data may be stored at a plurality of sampling rates. For example, newer data is stored at a first sampling rate and older data is stored at a second sampling rate, which is less frequent than the first sampling rate. In the exemplary system 100, the processor 104 obtains the data at the first sampling rate. That is, the processor 104 obtains data at predetermined periodic time period. In the exemplary embodiments, the first sampling rate is one sample per second. However, it should be appreciated that the first sampling rate may be accomplished at any time period achievable by the processor 104.

In the exemplary embodiments, the older data stored at the second sampling rate is the same data that was stored at the first sampling rate but simply maintained at the second sampling rate. Said another way, as newer data is received, one part of the older data is maintained, but another part is overwritten by the newly received data. As a result, data at multiple sampling rates is achieved.

The data may be stored at more than the two sampling rates described above. In the exemplary embodiments described herein, the received data is stored at three sampling rates: the first sampling rate, the second sampling rate, and a third sampling rate. The third sampling rate is less frequent than the second sampling rate, which, as previously stated, is less frequent than the first sampling rate. Of course, any number of sampling rates may be stored utilizing the system 100 and methods 300 described herein.

As such, the method 300 includes sampling the received data. More specifically, the exemplary method 300 includes, at 304, sampling the data at a first sampling rate. The method 300 further includes, at 306, determining a current storage location address for a latest sample of the data at the first sampling rate such that older samples of data are retained at the second sampling rate. The method 300 also includes, at 308, storing the latest sample of the data at the current storage location address.

Determining the current storage location address may be performed utilizing modular arithmetic. That is, at least one mathematical computation used in determining the current storage location address involves a modulo operation.

Two separate techniques for determining the current storage location are described herein. In a first exemplary embodiment, determining the current data storage location address Addₛ is determined with the expression:

$${Add}_{s} = {Add}_{m i n} + \{ {\sum }_{k = 1}^{{T}_{s} mod ModIdx} {M}_{ma x ( k - 1 )} \} + {T}_{s} mod {M}_{ma x ( {T}_{s} m od ModIdx )}$$

wherein Addₘᵢₙ is a minimum address, ModIdx is a modula index equal to the number of arrays, Tₛ is a consecutive integer representing the latest sample of the data, and M_{max n} represents the size of the respective array.

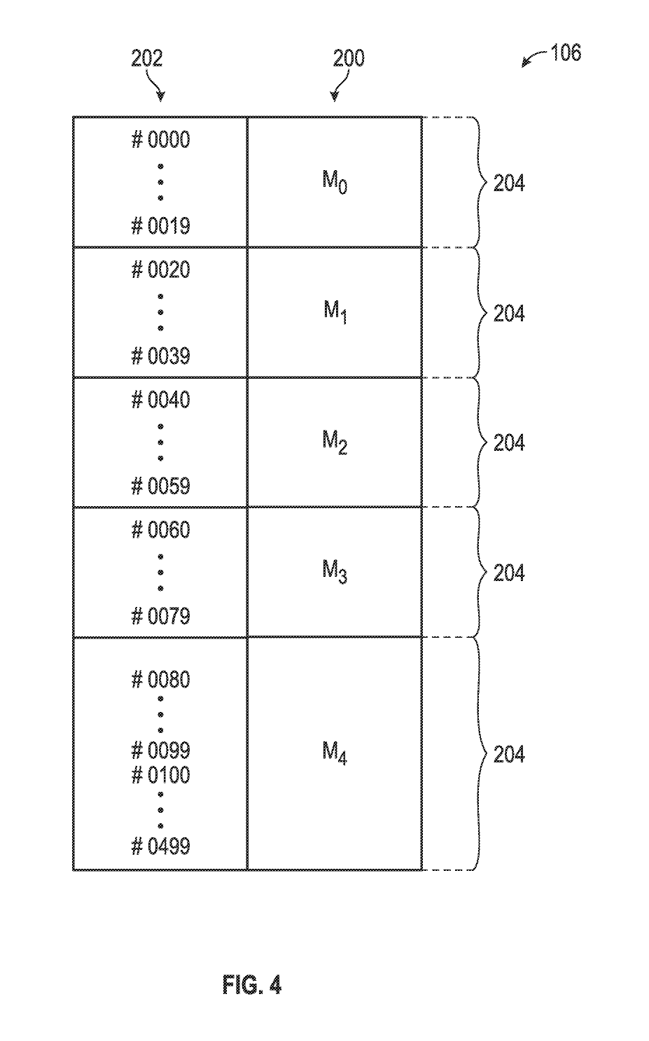

In one implementation of the first exemplary embodiment, 100 samples of newer data are stored at a one sample per second (1 s/sample) sampling rate (i.e., the first sampling rate) and 400 samples of older data are stored at a one sample every five seconds (5 s/sample) sampling rate (i.e., the second sampling rate). Said another way, 100 newer data samples are stored every second and 400 older data samples are stored every five seconds. In this implementation of the first exemplary embodiment, as shown in FIG. 4, the memory 106 is partitioned into a plurality of arrays 204. More specifically, the memory 106 is partitioned into a four arrays 204 labeled M₀-M₄, each having 20 data storage locations, and one array 204 labeled M₄ having 420 data storage locations.

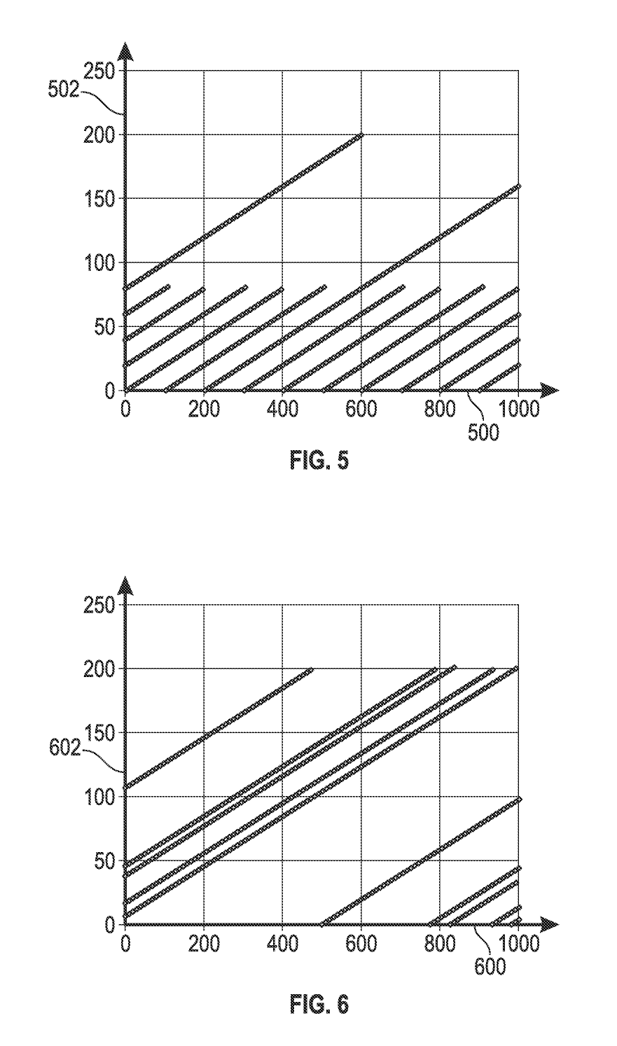

In this implementation, the minimum address Addₘᵢₙ is zero and ModIdx is five. Therefore, the current data storage location address Addₛ proceeds as {0, 20, 40, 60, 80, 1, 21, 41, 61, 81, . . . , 19, 39, 59, 79, 99, 0, 20, 40, 60, 100, 1, 21, 41, 61, 101, . . . }. A graphical representation of the data storage addresses over time can be seen in FIG. 5, wherein the horizontal axis 500 reflects time (or Tₛ) and the vertical axis 502 reflects the data storage location addresses 202.

Implementing the first exemplary embodiment described above results in a memory having data at a plurality of sampling rates, while only recording data at one sampling rate, i.e., the first sampling rate. Moreover, the method of the first exemplary embodiment is fairly simple to implement in program form in the processor 104.

In a second exemplary embodiment, determining the current data storage location address Addₛ is determined with the expression:

$${Add}_{s} = {Add}_{m i n} + \frac{\{ {\sum }_{k = 1}^{kmax} ( int ( \frac{{T}_{m}}{{R}_{k}} ) * {N}_{k} ) \} + {T}_{m} - 1 - {T}_{s}}{LCM} mod {\sum }_{k = 1}^{kma x} {N}_{k}$$

wherein Addₘᵢₙ is the minimum address, Tₛ is the consecutive integer representing the latest sample of the data, LCM is the least common multiple of the sampling rates, Tₘ equals (Tₛ mod LCM)+1, Rₖ is the sampling rate, Nₖ is the number of samples at Rₖ, and kₘₐₓ is the total number of sampling rates to be stored. The function int(x) rounds down “x” to the nearest integer.

In one implementation of the second exemplary embodiment, 1000 samples of newer data are stored at a one sample per second (1 s/sample) sampling rate (i.e., the first sampling rate), 2000 samples of older data are stored at a one sample every two seconds (2 s/sample) sampling rate (i.e., the second sampling rate), and 1000 samples of even older data are stored at a one sample per 10 seconds (10 s/sample) sampling rate (i.e., the third sampling rate).

In this implementation, the minimum address Addₘₘ is zero, LCM is 10, and kₘₐₓ is three. Therefore, the current data storage location address Addₛ proceeds as {100, 600, 700, 1200, 1300, 1800, 1900, 2400, 2500, 0, 99, 599, . . . }. A graphical representation of the data storage addresses over time can be seen in FIG. 6, wherein the horizontal axis 600 reflects time (or Tₛ) and the vertical axis 602 reflects the data storage location addresses.

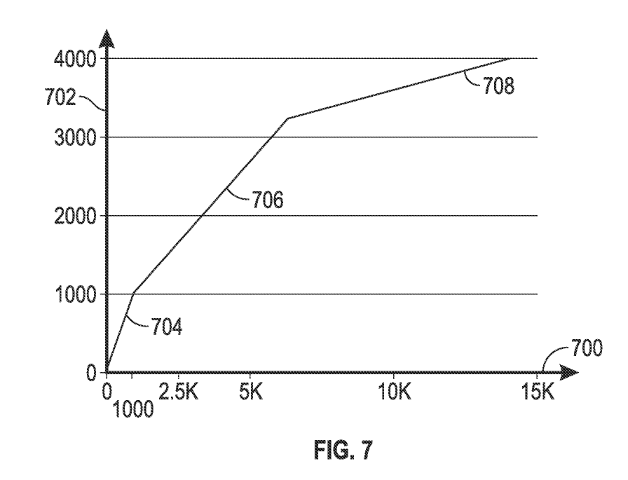

The sampling rates and the quantity of data stored utilizing the second exemplary embodiment can be seen with reference to FIG. 7. Specifically, the horizontal axis 700 represents time and the vertical axis 702 represents the number of data storage locations utilized. Three sections 704, 706, 708 of a curve (not separately numbered) represent the three different sampling rates utilized in the second exemplary embodiment. Specifically, section 704 represents 1000 samples stored at one sample every second, section 706 represents 2000 samples stored at one sample every two seconds, and section 708 represents 1000 samples stored at one sample every ten sections.

Implementing the second exemplary embodiment described above also results in a memory having data at a plurality of sampling rates, while only recording data at one sampling rate, i.e., the first sampling rate. Moreover, the method of the second exemplary embodiment utilizes the same write rate at all data storage locations by cycling through the various spacing between writes at all memory locations.

Referring again to FIG. 3, the method 300 may also include, at 310, receiving an event notification. As one example, the event notification may be an indication of an impact event from an accelerometer. Other event notifications may occur due to an engine stall and/or a diagnostic code setting. Furthermore, those skilled in the art will appreciate numerous event notifications that may be generated and received.

In response to receiving the event notification, the method 300 may further include, at 312, communicating the data stored in the memory locations 200 in response to receiving the event notification. The data stored in the memory locations 200 may be sent to the radio 110 for transmission to a remote server 112, in response to the event notification. In another exemplary embodiment (not shown), the data stored in the memory locations 200 may simply be written to another section of the memory 106 for later retrieval. By sending the data in response to an event notification, the data present at the time of the event may be analyzed to determine the cause of the event and/or the reaction to the event.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of recording data in a memory having a plurality of data storage locations, said method comprising:
receiving data;
sampling the data at a first sampling rate;
determining a current storage location address for a latest sample of the data at the first sampling rate such that older samples of data are retained at a second sampling rate less frequent than the first sampling rate; and
storing the latest sample of the data at the current storage location address.

2. The method as set forth in claim 1, wherein determining the current storage location is performed utilizing modular arithmetic.

3. The method as set forth in claim 1, further comprising partitioning the data storage locations of the memory into a plurality of arrays.

4. The method as set forth in claim 3, wherein determining the current storage location address (Addₛ) is determined with the expression:
$${Add}_{s} = {Add}_{m i n} + \{ {\sum }_{k = 1}^{{T}_{s} mod ModIdx} {M}_{ma x ( k - 1 )} \} + {T}_{s} mod {M}_{ma x ( {T}_{s} m od ModIdx )}$$
wherein Addₘᵢₙ is a minimum address, ModIdx is a modula index equal to the number of arrays, Tₛ is a consecutive integer representing the latest sample of the data, and M_{max n} represents the size of the respective array.

5. The method as set forth in claim 1, wherein determining a current storage location address comprises determining a current storage location address for a latest sample of the data at the first sampling rate such that older samples of data are retained at a second sampling rate less frequent than the first sampling rate and a third sampling rate less frequent than the second sampling rate.

6. The method as set forth in claim 1, wherein determining the current storage location address (Addₛ) is determined with the expression:
$${Add}_{s} = {Add}_{m i n} + \frac{\{ {\sum }_{k = 1}^{kmax} ( int ( \frac{{T}_{m}}{{R}_{k}} ) * {N}_{k} ) \} + {T}_{m} - 1 - {T}_{s}}{LCM} mod {\sum }_{k = 1}^{kma x} {N}_{k}$$
wherein Addₘᵢₙ is a minimum address, Tₛ is a consecutive integer representing the latest sample of the data, LCM is the least common multiple of the sampling rates, Tₘ=(Tₛ mod LCM)+1, Rₖ is the sampling rate, Nₖ is the number of samples at Rₖ, and kmax is the total number of sampling rates to be stored.

7. The method as set forth in claim 1, further comprising receiving an event notification.

8. The method as set forth in claim 7, further comprising communicating the data stored in the data storage locations in response to receiving the event notification.

9. A system for recording data, comprising:
a processor configured to receive data from at least one data source and sample the data at a first sampling rate;
a memory in communication with said processor including a plurality of storage locations each identified with a unique address; and
wherein said processor is further configured to determine a current storage location address for a latest sample of the data at the first sampling rate such that older samples of data are retained at a second sampling rate less frequent than the first sampling rate.

10. The system as set forth in claim 9, wherein said processor is configured to determine the current storage location utilizing modular arithmetic.

11. The system as set forth in claim 9, wherein said data storage locations of said memory are partitioned into a plurality of arrays.

12. The system as set forth in claim 11, wherein said processor is configured to determine the current storage location address (Addₛ) with the expression:
$${Add}_{s} = {Add}_{m i n} + \{ {\sum }_{k = 1}^{{T}_{s} mod ModIdx} {M}_{ma x ( k - 1 )} \} + {T}_{s} mod {M}_{ma x ( {T}_{s} m od ModIdx )}$$
wherein Addₘᵢₙ is a minimum address, ModIdx is a modula index equal to the number of arrays, Tₛ is a consecutive integer representing the latest sample of the data, and M_{max n} represents the size of the respective array.

13. The system as set forth in claim 9, wherein said processor is configured to determine a current storage location address for a latest sample of the data at the first sampling rate such that older samples of data are retained at a second sampling rate less frequent than the first sampling rate and a third sampling rate less frequent than the second sampling rate.

14. The system as set forth in claim 9, wherein said processor is configured to determine the current storage location address (Addₛ) with the expression:
$${Add}_{s} = {Add}_{m i n} + \frac{\{ {\sum }_{k = 1}^{kmax} ( int ( \frac{{T}_{m}}{{R}_{k}} ) * {N}_{k} ) \} + {T}_{m} - 1 - {T}_{s}}{LCM} mod {\sum }_{k = 1}^{kma x} {N}_{k}$$
wherein Addₘᵢₙ is a minimum address, Tₛ is a consecutive integer representing the latest sample of the data, LCM is the least common multiple of the sampling rates, Tₘ=(Tₛ mod LCM)+1, Rₖ is the sampling rate, Nₖ is the number of samples at Rₖ, and kmax is the total number of sampling rates to be stored.

15. The system as set forth in claim 9, wherein said processor is configured to receive an event notification.

16. The system as set forth in claim 15, wherein said processor is configured to send the data stored in the data storage locations in response to receiving the event notification.

17. A vehicle, comprising:
a sensor for sensing an aspect of said vehicle;
a processor configured to receive data from said sensor and sample the data at a first sampling rate;
a memory in communication with said processor including a plurality of storage locations each identified with a unique address; and
wherein said processor is further configured to determine a current storage location address for a latest sample of the data at the first sampling rate such that older samples of data are retained at a second sampling rate less frequent than the first sampling rate.

18. The vehicle as set forth in claim 17, wherein said processor is configured to receive an event notification;

19. The vehicle as set forth in claim 18, further comprising a radio in communication with said processor, said radio configured to communicate the data stored in the data storage locations in response to receiving the event notification.
